(19) United States
(12) Patent Application Publication
(10) Pub. No.: US 2025/0388392 A1
(43) Pub. Date: Dec. 25, 2025

(54) Trash Collecting Container

(71) Applicant: Brent Michael Campagnolo, Santa Cruz, CA (US)

(72) Inventor: Brent Michael Campagnolo, Santa Cruz, CA (US)

(21) Appl. No.: 19/307,041

(22) Filed: Aug. 22, 2025

(51) Int. Cl. B65F 1/02; B65F 1/14

(52) U.S. Cl. CPC B65F 1/02; B65F 1/1473; B65F 2250/114

(57) ABSTRACT

A trash-collecting container is designed to enable efficient collection, transportation, and disposal of waste and debris, while being adaptable to enhance ergonomics, improve mobility, and provide stability during use. The trash collecting container comprises a body defining a chamber to collect and store waste and debris. The body comprises an elongated trailing edge at a front portion to flush with a surface when it is oriented in a sweeping position, thereby facilitating effective debris collection. Furthermore, the trash collecting container comprises a plurality of wheels that enable the user for changing a position of the trash collecting container between a sweeping position and an upright position, and facilitating safe and quicker transport from one location to a dust disposal site, and a handle that enables the user to securely hold while changing the position of the trash collecting container and transporting the collected waste and debris.

### FIELD OF THE INVENTION

The present disclosure relates generally to cleaning devices and waste collection equipment, and more particularly to a trash-collecting container is designed to enable efficient collection, transportation, and disposal of waste and debris, while being adaptable to enhance ergonomics, improve mobility, and provide stability during use.

### BACKGROUND

Cleaning tasks, whether in residential, commercial, or industrial settings, often involve repetitive actions such as sweeping, bending, lifting, and transporting debris. Traditional cleaning tools, such as dust pans and garbage bins, require users to bend frequently to collect debris and lift heavy loads for disposal. These repetitive movements can lead to physical strain, particularly in the back, shoulders, and knees, causing discomfort or even long-term injury. There is a growing demand for cleaning solutions that reduce the physical effort required while improving efficiency and user comfort.

Conventional dust pans are typically handheld and designed to collect debris by placing the pan flat on the ground while sweeping debris into it. However, these pans often have limited capacity and require users to repeatedly bend down, thereby making them inconvenient for larger cleaning tasks. On the other hand, garbage bins are generally stationary and do not provide an integrated mechanism for debris collection, necessitating the use of separate tools for sweeping and waste disposal. This separation increases the time and effort needed to complete cleaning tasks, especially in large areas.

While some garbage bins and dust pans have incorporated wheels to facilitate transport, these designs often suffer from poor maneuverability and stability. Wheels in traditional bins are either too small to handle uneven surfaces effectively or are placed in positions that make the bin prone to tipping. Furthermore, many wheeled bins lack an ergonomic handle design, forcing users to either stoop to push or pull the bin or lift it entirely, negating the intended benefits of mobility.

Stability is a critical issue in conventional cleaning tools. Dust pans are often lightweight and prone to tipping when debris is swept into them, causing frustration and additional work for the user. Similarly, garbage bins can become unstable, particularly when loaded with heavy debris or when being transported over uneven surfaces. Achieving a balance between mobility and stability remains a challenge in existing designs, as many fail to provide a secure base while ensuring ease of movement.

Another significant problem with traditional dust pans is their inability to collect debris efficiently in a single sweep. The narrow openings and flat surfaces often leave gaps, requiring users to make multiple passes to clear all debris. Additionally, conventional designs struggle to handle various types of debris, from fine dust to larger particles or heavier materials. This inefficiency leads to increased time and effort spent on cleaning tasks, which can be particularly problematic in commercial or industrial settings where time is a critical factor.

In existing technology, a pan with rolling trash receptacle is known. The pan having brackets formed to engage the rim of the receptable's opening, thereby allowing the debris to be swept directly into the pan and subsequently deposited into the receptacle. Additionally, the pan elevates the rim of the receptacle, causing the debris to slide toward the bottom. When the receptacle is upright, the pan enables the easy and efficient transfer of the debris into the container or trash bag. But here the pan utilizes more space, which is difficult to the user to be positioned in their residence, and commercial cleaning applications.

Therefore, there is a need for a trash collecting container that utilizes less space to be positioned in their residential, commercial, and industrial environments. There is also a need for a trash collecting container that allows to collect the debris from a ground surface, thereby reducing the minimal effort on the user. There is also a need for a trash collecting container that utilizes a thickened rear base to withstand heavy use in both indoor and outdoor environments. Furthermore, there is also a need for a trash collecting container that reduces maintenance and replacements costs over time.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a trash collecting container. In one embodiment herein, the trash collecting container comprises a body, a plurality of wheels, at least one handle, a pair of holding members, and an impact-guarded runner.

In one embodiment herein, the body defining a chamber to collect and store waste and debris through an opening. The body comprises an elongated trailing edge at a front portion to flush with a surface when the trash collecting container is oriented in a sweeping position, thereby facilitating effective debris collection.

In one embodiment herein, the plurality of wheels is rotatably affixed to the body at a rear portion. The plurality of wheels is configured to enable a user for changing a position of the trash collecting container between the sweeping position and an upright position, and facilitating safe and quicker transport from one location to a dust disposal site. The plurality of wheels is prepared by a durable, non-slip material to provide traction and ensure smooth movement across various surfaces during transportation.

In one embodiment herein, the at least one handle is affixed to the rear portion of the body. The at least one handle is configured to enable the user to securely hold while changing the position of the trash collecting container and transporting the collected waste and debris.

In one embodiment herein, the pair of holding members integrated with the body on both sides, wherein the pair of holding members is configured to enable the user to securely hold and effectively lift, push, pull, and carry the trash collecting container for handling the collected waste and debris.

In one embodiment herein, the impact-guarded runner is affixed to the body at a bottom portion. The impact-guarded runner is configured to stabilize the trash collecting container while changing the position between the sweeping position and the upright position. The impact-guarded runner is adapted to protect the bottom portion of the trash collecting container from damages caused by impacts, collisions, and rough surfaces.

In one embodiment herein, the trash collecting container is made of a durable plastic material specifically designed to withstand outdoor conditions. The trash collecting container comprise at least one of a shape includes square, rectangular, and trapezoidal. The trash collecting container further comprises at least one slotted section affixed to the rear portion of the body, wherein the at least one slotted section is configured to allow the user to simply lift the trash collecting container while dumping the waste and debris.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a front schematic view of a trash collecting container, in accordance with embodiments of the invention.

FIG. 2 illustrates a rear schematic view of the trash collecting container, in accordance with embodiments of the invention.

FIG. 3 illustrates a side schematic view of the trash collecting container, in accordance with embodiments of the invention

FIGS. 4-5 illustrate lateral perspective views of the trash collecting container, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

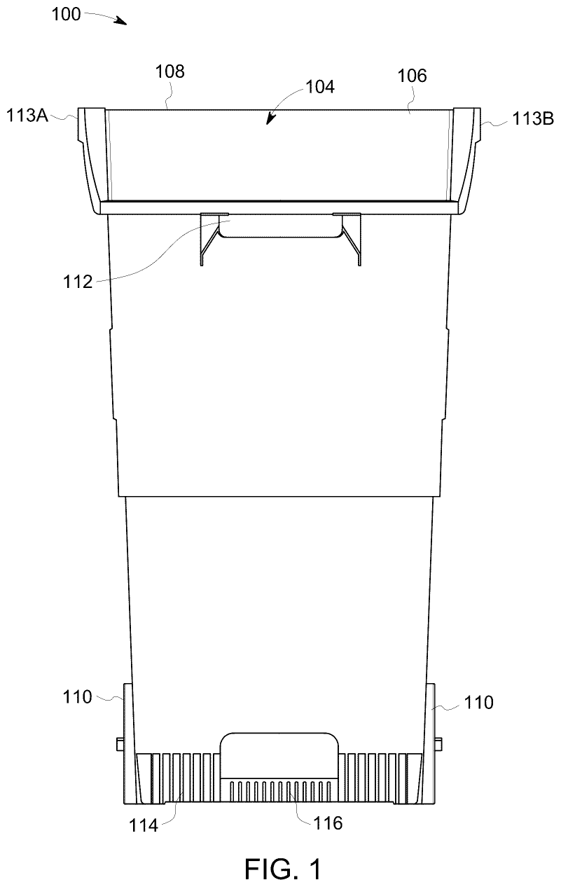

FIG. 1 refers to a front schematic view of a trash collecting container 100. In one embodiment herein, the trash collecting container 100 comprises a body 102, and a plurality of wheels 110. The trash collecting container 100 is configured to facilitate a user to efficient collection, transportation, and disposal of debris and is adaptable to improve ergonomics, enhance mobility, and provide stability during use. Additionally, the body 102 defines a chamber 104 to collect and store waste and debris through an opening 106. The body 102 is configured to provide structural support to the trash collecting container 100, thereby facilitating effective debris collection through the opening 106. In one example, the trash collecting container 100 is prepared with high-strength materials, such as reinforced plastic and metal.

In one embodiment herein, the body 102 comprises an elongated trailing edge 108, at least one handle 112, a pair of holding members (113A, 113B), an impact guarded runner 114, and a slotted section 116. In one embodiment herein, the elongated trailing edge 108 is securely attached to the body 102 at a top portion. The elongated trailing edge 108 is configured to facilitate efficient debris collection when the user manually orients it in a sweeping position by gripping the handle 112, which is positioned opposite the elongated trailing edge 108. Additionally, the handle 112 is configured to allow the user to easily grip and transport the trash collecting container 100 along with collected debris using the plurality of wheels 110.

In one embodiment herein, the plurality of wheels 110 is rotatably mounted at a rear portion of the body 102. The plurality of wheels 110 is configured to enable rolling movement of the trash collecting container 100 across various surfaces for collecting the debris and transferring it from one place to another. In one embodiment herein, the plurality of wheels 110 are positioned on opposite sides of the body 102 of the trash collecting container 100 to provide balanced support, smooth rolling rotation, and enhanced stability during transport across various surfaces.

In one embodiment herein, the at least one handle 112 is affixed to the rear and top portion of the body 102. The at least one handle 112 is configured to enable the user to securely hold while changing the position of the trash collecting container 100 and transporting the collected waste and debris. The at least one handle 112 is adapted to allow the user to tilt the trash collecting container 100 forward by applying downward pressure, causing the trash collecting container 100 to make direct contact with the ground surface via the plurality of wheels 110, thereby enabling the user to sweep the debris and waste efficiently into the chamber 104.

In one embodiment herein, the elongated trailing edge 108 ensure the maintenance of structural integrity even under heavy loads of debris. In one embodiment herein, the impact-guarded runner 114 is adapted to protect the bottom portion of the trash collecting container 100 from damages caused by impacts, collisions, and rough surfaces. The impact-guarded runner 114 reinforced with high-impact resistant materials, ensuring that it withstands repeated contact with the ground without significant wear, thereby prolonging the life span of the trash collecting container 100.

In one example, the elongated trailing edge 108 having a flat scraping edge at angled downward and outward to maximize contact with a ground surface while the user tilts the trash collecting container 100, thereby allowing the debris collection with minimal effort and ensuring that debris such as dust, dirt, leaves, and small particles is easily swept into the chamber 104 with minimal effort. Furthermore, the elongated trailing edge 108 is made up of high-impact, wear-resistant materials, such as reinforced plastic, rubber, or metal, and adapted to withstand frequent use on various surfaces, including rough or abrasive terrain. The materials used provide excellent durability, thereby ensuring the elongated trailing edge 108 maintains its effectiveness over time without significant wear or deformation. Additionally, the flat scraping edge of the elongated trailing edge 108 might be coated or reinforced to resist cracking, chipping, or fraying, further extending its lifespan.

In one embodiment herein, the slotted section 116 is affixed to the rear portion of the body 102. The slotted section 116 is configured to allow the user to simply lift the trash collecting container 100 while dumping the waste and debris. Furthermore, the slotted section 116 is configured to provide additional control and stability during various operational tasks, thereby enhancing the user's ability to lift trash collecting container 100, Additionally, the handle 112 is configured to facilitate the user to lift, push, pull, and carry the trash collecting container 100.

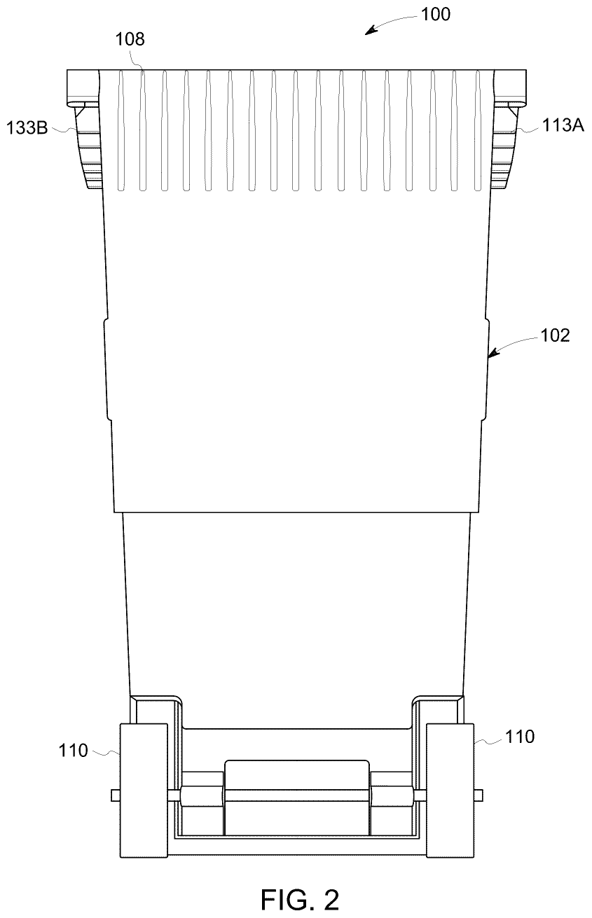

FIG. 2 refers to a rear schematic view of the trash collecting container 100. In one embodiment herein, the plurality of wheels 110 is rotatably mounted at the rear portion of the body 102. The plurality of wheels 110 is configured to enable rolling movement of the trash collecting container 100 across various surfaces for collecting the debris and transferring it from one place to another. Additionally, the plurality of wheels 110 are positioned on opposite sides of the body 102 of the trash collecting container 100 to provide balanced support, smooth rolling rotation, and enhanced stability during transport across various surfaces.

In one embodiment herein, the pair of holding members (113A, 113B) is positioned on the top portion of the body 102 and opposite sides of the body 102 of the trash collecting container 100. The pair of holding members (113A, 113B) is configured to facilitate the user to securely grip and effectively lift, push, pull, and carry the trash collecting container 100. Additionally, the pair of holding members (113A, 113B) is precisely integrated with the body 102 at the upper side of the trash collecting container 100. The pair of holding members (113A, 113B) is adapted to provide ergonomic control during tilting and transport operations. In one embodiment herein, the elongated trailing edge 108 ensures the structural integrity is maintained even under heavy loads of debris.

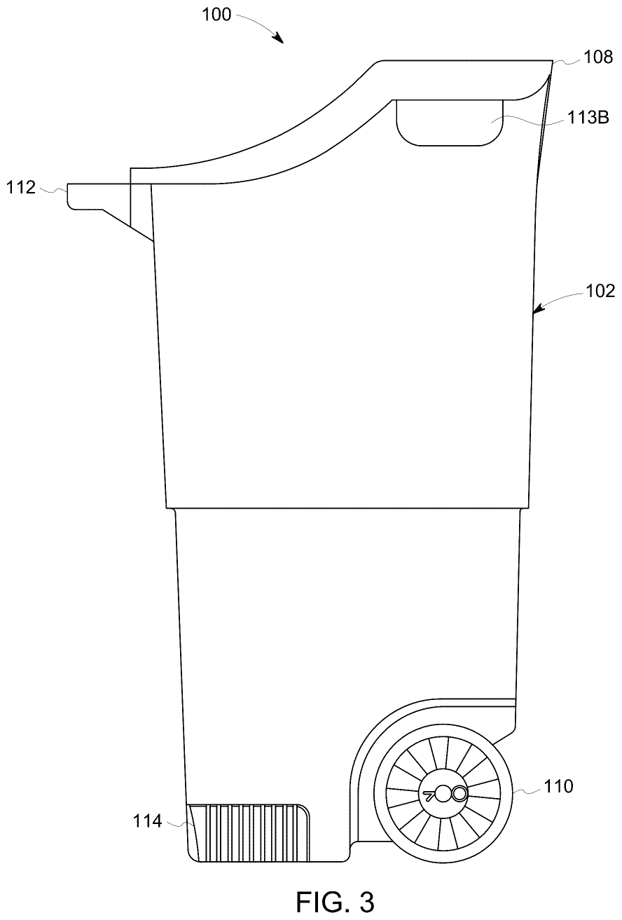

FIG. 3 refers to a side schematic view of the trash collecting container 100. In one embodiment herein, the at least one holding member 113B is positioned on the top portion of the body 102 and opposite sides of the body 102 of the trash collecting container 100. The at least one holding member 113B is configured to facilitate the user to securely grip and effortlessly lift, push, pull, and carry the trash collecting container 100. Additionally, the at least one holding member 113B is precisely integrated with the body 102 at the upper side of the trash collecting container 100, thereby ensuring a stable and durable connection. The at least one holding member 113B is adapted to provide ergonomic control during tilting and transport operations.

In one embodiment herein, the elongated trailing edge 108 is configured to flush with the ground when the trash collecting container 100 is tilted to the sweeping position by the user via the handle 112 and the at least one holding member 113B, thereby enabling efficient debris collection with minimal gaps. In one embodiment herein, the impact guarded runner 114 is positioned along the bottom rear portion of the trash collecting container 100. The impact-guarded runner 114 provides stability when the trash collecting container 100 is placed in the upright position and protects the bottom surface from damage caused by impacts, collisions, or contact with rough ground surfaces.

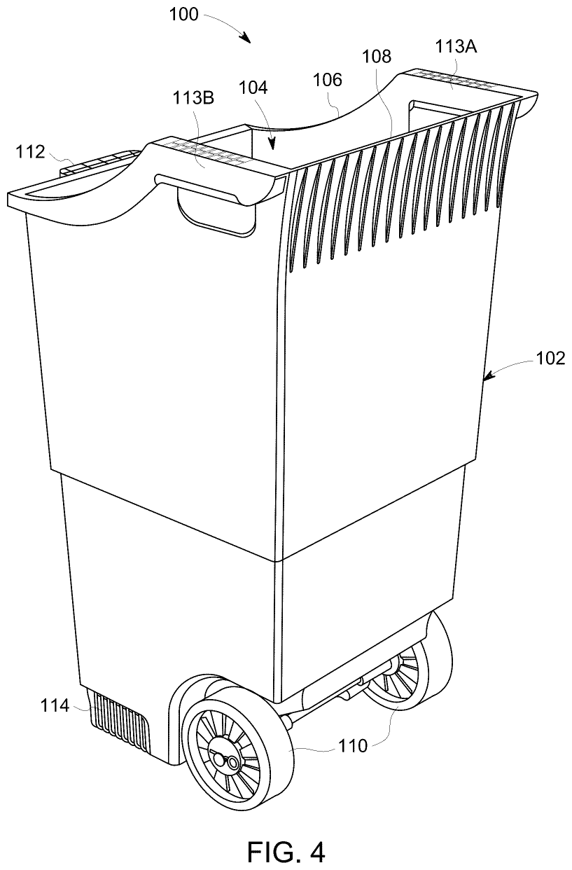

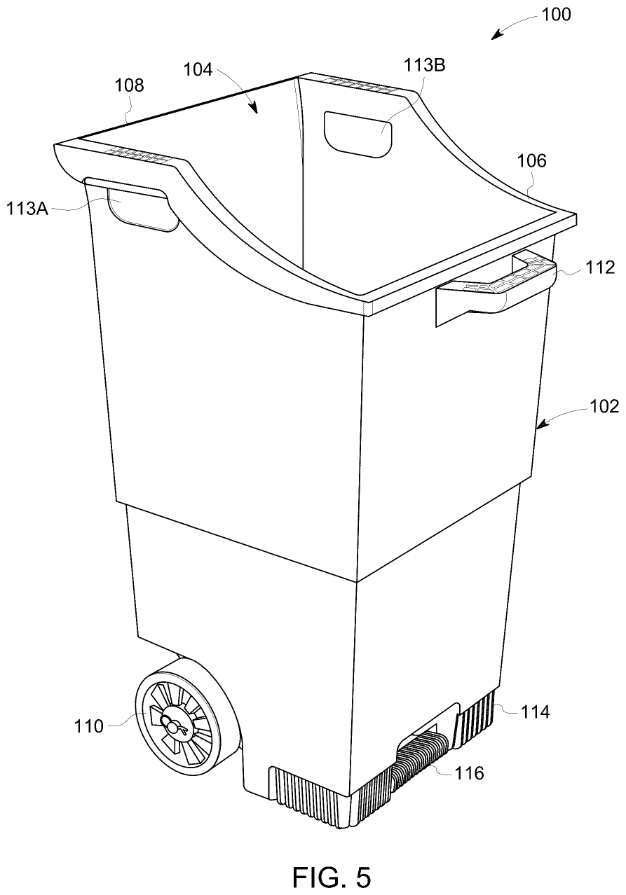

FIGS. 4-5 refer to lateral perspective views of the trash collecting container 100. In one embodiment herein, the body 102 serves as a main body to collect and store the debris. In one embodiment herein, the trash collecting container 100 comprises at least one of a shape includes square, rectangular, and trapezoidal. Basically, the trash collecting container 100 is supported on the ground surface via the plurality of wheels 110 and the impact-guarded runner 114 to collect the debris as it is swept into the chamber 104.

In one embodiment herein, the impact-guarded runner 114 ensures maximum contact with the ground surface and allows for debris to be directed efficiently into the chamber 104 without spilling when the trash collecting container 100 is tilted to the sweeping position. The impact-guarded runner 114 ensures maximum contact with the ground surface and allows for debris to be directed efficiently into the chamber 104 without spilling. In one embodiment herein, the plurality of wheels 110 are positioned on the bottom portion of the trash collecting container 100. The plurality of wheels 110 is configured to enable the user to change the position of the trash collecting container 100 between the sweeping position and the upright position, and facilitating safe and quicker transport from one location to the dust disposal site.

In one example embodiment, each wheel of the plurality of wheels 110 is detachably attached to the body 102 via a secure locking pin mechanism, allowing for quick installation, removal, and replacement of the plurality of wheels 110 without requiring specialized tools. The locking pin assembly includes a reinforced axle portion integrated into the lower rear structure of the body 102, onto which the plurality of wheels 110 is mounted. A locking pin extends through aligned apertures formed within the wheel hub and the axle, securely retaining the wheel in place during operation. Additionally, the locking pin is configured with a quick-release feature, enabling the user to disengage the plurality of wheels 110 from the axle by simply retracting the pin. This detachable wheel arrangement enhances the maintainability and versatility of the trash collecting container 100, allowing for efficient servicing, transportation, or storage when required.

In one embodiment herein, the trash collecting container 100 having a width of 20 inches and a depth of 17 inches. The trash collecting container 100 features 15 inches of at least one handle 112 supported by three vertical supports, thereby ensuring stability and ease of handling. The depth of the at least one handle 112 extends beyond the body 102 at the bottom portion, thereby providing a firm grip for maneuvering. The height of at least one handle 112 from the bottom portion of the body 102 is 40 inches, while the height of the trash collecting container 100 is 33 inches. Additionally, the trash collecting container 100 demonstrates superior floor stability owing to its geometrically optimized square or rectangular base, which offers a broad, uniformly distributed footprint. This structural configuration significantly reduces the likelihood of tipping, rocking, or imbalance during operation when subjected to uneven loads or while maneuvering across varied surface conditions with heavy debris.

In one example, the at least one handle 112 and the pair of holding members (113A, 113B) are prepared with durable material with rubber that is easy to roll the trash collecting container 100, thereby reducing the user fatigue and enhancing overall efficiency during debris collection and transportation. In another example embodiment herein, the trash collecting container 100 is taller than conventional designs, thereby improving ergonomic efficiency and capacity. Additionally, the trash collecting container 100 is user-friendly, and efficient for collecting and transporting the debris across the various surfaces.

In another embodiment herein, the at least one handle 112, the pair of holding members (113A, 113B), and the at least one slotted section 116 are configured to provide a comprehensive control system for rolling the trash collecting container 100 during use, thereby reducing user fatigue and enhancing overall efficiency during debris collection and transportation. The each holding member of the pair of holding members (113A, 113B) is ergonomically configured to fit in the user's hand during lifting and transport operations.

In one embodiment herein, the trash collecting container 100 is adapted to provide an innovative solution for sweeping the debris and waste into the chamber 104 that might be easily maneuverer across various surfaces. The trash collecting container 100 includes multiple components that work together to provide a lightweight, durable, and easy-to-use. In one example, the body 102 is made of lightweight, durable plastic to withstand daily use and exposure to outdoor environments.

In another embodiment herein, the body 102 is structurally configured to impart enhanced stability and mechanical support to the trash collecting container 100, both in its stationary upright position and when tilted during debris collection operations. The body 102 features a flat, broad base geometry designed to optimize balance and ensure uniform, consistent contact with the ground surface, thereby minimizing the risk of tipping or uneven operation. The chamber 104 is integrally defined within the body 102, and is dimensioned to accommodate a substantial volume of waste and debris, thereby significantly reducing the frequency of emptying cycles and improving overall operational efficiency.

In one embodiment herein, the trash collecting container 100 having 20 inches by 20 inches from the top view, thereby creating the opening 106 or debris collection. The impact-guarded rubber 114 is slightly narrower with 17 inches by 17 inches, thereby enhancing stability and ensuring the trash collecting container 100 remains balanced during use. In one embodiment herein, the plurality of wheels 110 having dimensions of 7 inches that facilitate smooth movement across various surfaces. The at least one slotted section 116 having a diameter of 1.5 inches, thereby offering a comfortable grip for the user.

In one example embodiment herein, the trash collecting container 100 is configured with a tapered lower body profile. The body 102 narrows towards the bottom portion, allowing multiple containers to be inserted one into another in a vertically stacked arrangement. This arrangement significantly reduces the required storage space when two or more trash collecting containers 100 are not in active use, thereby facilitating compact storage in residential, commercial, or industrial environments. The stackable configuration simplifies bulk transportation of one or more trash collecting containers 100, enabling efficient shipment and handling. The stackable configuration ensures easy separation of containers and prevents deformation or jamming during stacking, thereby maintaining structural integrity and facilitating convenient handling and space optimization.

In another example embodiment herein, the trash collecting container 100 has an elongated half-moon shape, configured with a flat rear surface for stable placement and the elongated trailing edge 108 at the front that facilitates ground-level debris collection. The structure incorporates an inclined top contour to guide swept debris efficiently into the chamber 104, the pair of holding members (113A, 113B) is positioned at the highest point for ergonomic gripping, and it is integrated with the plurality of wheels 110 that enable smooth rolling during transport. Additionally, the impact-guarded runner 114 is adapted to protect the bottom portion of the trash collecting container 100 from damages caused by impacts, collisions, and rough surfaces. Additionally, the plurality of wheels 110 for mobility and the at least one handle 112 allow the user to clean and transport waste with minimal bending or lifting effort of the trash collecting container 100. The trash collecting container 100 is a compact, integrated form factor intended to optimize indoor space utilization and improve cleaning efficiency.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A trash collecting container, comprising:
a body defining a chamber to collect and store waste and debris through an opening,
wherein the body comprises an elongated trailing edge at a front portion to flush with a surface when the trash collecting container is oriented in a sweeping position, thereby facilitating debris collection;
a plurality of wheels rotatably affixed to the body at a rear portion, wherein the plurality of wheels is configured to enable a user for changing a position of the trash collecting container between the sweeping position and an upright position, and facilitating safe and quicker transport from one location to a dust disposal site; and
at least one handle affixed to the rear portion of the body, wherein the at least one handle is configured to enable the user to securely hold while changing the position of the trash collecting container and transporting the collected waste and debris.

2. The trash collecting container of claim 1, wherein the trash collecting container is made of a durable plastic material configured to withstand outdoor environmental conditions.

3. The trash collecting container of claim 1, wherein the body further comprises an impact-guarded runner at a bottom portion, wherein the impact-guarded runner is configured to stabilize the trash collecting container while changing the position between the sweeping position and the upright position.

4. The trash collecting container of claim 3, wherein the impact-guarded runner is adapted to protect the bottom portion of the trash collecting container from damages caused by impacts, collisions, and rough surfaces.

5. The trash collecting container of claim 1, wherein the trash collecting container comprise at least one of a shape from a group includes square, rectangular, and trapezoidal.

6. The trash collecting container of claim 1, wherein the plurality of wheels is prepared by a durable, non-slip material to provide traction and ensure smooth movement across various surfaces during transportation.

7. The trash collecting container of claim 1, wherein the trash collecting container further comprises at least one slotted section affixed to the rear portion of the body, wherein the at least one slotted section is configured to allow the user to simply lift the trash collecting container while dumping the waste and debris.

8. A trash collecting container, comprising:
a body defining a chamber to collect and store waste and debris through an opening,
wherein the body comprises an elongated trailing edge at a front portion to flush with a surface when the trash collecting container is oriented in a sweeping position, thereby facilitating effective debris collection;
a plurality of wheels rotatably affixed to the body at a rear portion, wherein the plurality of wheels is configured to enable a user for changing a position of the trash collecting container between the sweeping position and an upright position, and facilitating safe and quicker transport from one location to a dust disposal site;
at least one handle affixed to the rear portion of the body, wherein the at least one handle is configured to enable the user to securely hold while changing the position of the trash collecting container and transporting the collected waste and debris;
a pair of holding members integrated with the body on both sides, wherein the pair of holding members is configured to enable the user to securely hold and effectively lift, push, pull, and carry the trash collecting container for handling the collected waste and debris; and
an impact-guarded runner affixed to the body at a bottom portion, wherein the impact-guarded runner is configured to stabilize the trash collecting container while changing the position between the sweeping position and the upright position.

9. The trash collecting container of claim 8, wherein the trash collecting container is made of a durable plastic material specifically designed to withstand outdoor conditions.

10. The trash collecting container of claim 8, wherein the impact-guarded runner is adapted to protect the bottom portion of the trash collecting container from damages caused by impacts, collisions, and rough surfaces.

11. The trash collecting container of claim 8, wherein the trash collecting container comprise at least one of a shape includes square, rectangular, and trapezoidal.

12. The trash collecting chamber of claim 8, wherein each of the holding member is ergonomically configured to fit in the user's hand during lifting and transport operations.

13. The trash collecting container of claim 8, wherein the plurality of wheels is prepared by a durable, non-slip material to provide traction and ensure smooth movement across various surfaces during transportation.

14. The trash collecting container of claim 8, wherein the trash collecting container further comprises at least one slotted section affixed to the rear portion of the body, wherein the at least one slotted section is configured to allow the user to simply lift the trash collecting container while dumping the waste and debris.
